(19) United States
(12) Patent Application Publication
(10) Pub. No.: US 2014/0120788 A1
(43) Pub. Date: May 1, 2014

(54) Flat Cable Connector

(71) Applicant: Tyco Electronics Japan G.K, Kanagawa-ken (JP)

(72) Inventors: Yoshihiko Kodaira, Kanagawa-ken (JP); Akira Kubo, Kanagawa-ken (JP); Hiroaki Kikuchi, Kanagawa-ken (JP)

(73) Assignee: TYCO ELECTRONICS JAPAN G.K., Kanagawa-ken (JP)

(21) Appl. No.: 14/068,550

(22) Filed: Oct. 31, 2013

(30) Foreign Application Priority Data
Oct. 31, 2012 (JP) 2012240830

(51) Int. Cl. H01R 13/447

(52) U.S. Cl. CPC H01R 13/447
USPC 439/892

(57) ABSTRACT

A flat cable connector is provides that includes a housing, a contact, and a cover member. The housing includes a top surface, a side surface adjacent the top surface, and a lock section disposed along the side surface. The contact is received in the housing and includes a portion protruding from the top surface. The cover member includes a planar surface and a lock extending from the planar surface and engageable with the lock section.

### CROSS-REFERENCE TO RELATED APPLICATIONS

This application claims the benefit of the filing date under 35 U.S.C. §119(a)-(d) of Japanese Patent Application No. 2012-240830, filed Oct. 31, 2012.

### FIELD OF INVENTION

The present invention relates to a cable connector and, more particularly, to a flat cable connector.

### BACKGROUND

A flat cable connector for connecting a flat cable represented by Flexible Flat Cable (FFC) or Flexible Printed Circuit (FPC)to a circuit board is generally known. For example, Japanese Utility Model Publication H6-60081A discloses an electrical connector for connecting a FPC. A reinforcement metal plate is attached at a tip of the FPC that connects to the electrical connector. A pair of metal securing members are provided in the electrical connector secure the FPC. The metal securing members extend upwards at areas corresponding to both sides of the FPC. When the FPC is pushed into an area between the pair of metal securing members, the metal securing members are pushed away by the FPC and the reinforcement plate to be deformed. When the FPC is completely pushed in, the metal securing members recover from being deformed to lock to a top surface of the reinforcement plate.

In addition, Japanese Patent Publication H9-161863A discloses an electrical connector in which contacts protrude from side surfaces of a housing. Upon connecting a FPC, when a cover member having a frame shape according to an appearance of the housing is pressed on the FPC that is put on the housing, the FPC is bent along a shape of the housing. The FPC is bent approximately perpendicularly along the side surface at a position thereof corresponding to the side surface of the housing to make contact with a contact.

Since the electrical connector of Japanese Utility Model Publication H6-60081A has a configuration in which the metal securing member locks to the top surface of the reinforcement plate attached to the FPC, the electrical connector is made high profile. In addition, in the electrical connector of Japanese Patent Publication H9-161863A, the cover member is pressed and the FPC is bent to make a connection, a large operation force is required and the operation of the connector is not easy. In addition, since the FPC is bent, the reliability may be decreased.

### SUMMARY

In view of the foregoing problems, the invention has been made to provide a flat cable connector whose connection operation is easy and is also made low profile.

The flat cable connector includes a housing, a contact, and a cover member. The housing includes a top surface, a side surface adjacent the top surface, and a lock section disposed along the side surface. The contact is received in the housing and includes a portion protruding from the top surface. The cover member includes a planar surface and a lock extending from the planar surface and engageable with the lock section.

### BRIEF DESCRIPTION OF THE DRAWINGS

The above and other features of the present invention will become more apparent by describing in detail exemplary embodiments thereof with reference to the accompanying drawings, in which:

FIG. 1 is a perspective view illustrating a flat cable connector according to the invention;

FIG. 2 is an exploded perspective view of the flat cable connector of FIG. 1;

FIG. 3 is an enlarged perspective view of a housing of the flat cable connector of FIG. 2;

FIG. 4 is a cross sectional view of the housing of FIG. 3 along the line 4-4, shown together with a corresponding cross section of a cover member and an FPC;

FIG. 5 is another cross sectional view of the housing illustrated in FIG. 3, along the line 4-4, shown together with a corresponding cross section of a cover member and an FPC;

FIG. 6 is a cross sectional view of the housing of FIG. 3, showing the FPC connected to the connector; and

FIG. 7 is a cross sectional view of the housing of FIG. 4, showing the FPC connected to the connector.

### DETAILED DESCRIPTION OF THE EMBODIMENT(S)

An embodiment of a flat cable connector 1 according to the invention will be described with reference to the attached drawings in the followings.

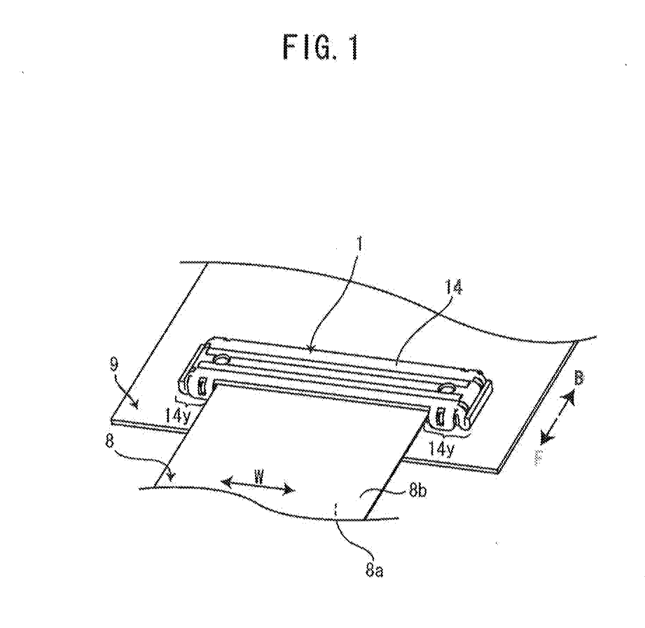

With reference to FIG. 1, the flat cable connector 1 (hereafter, simply referred to as connector 1) according to the present invention is shown, which is a connector to electrically connect a FPC 8 to a circuit board 9.

The FPC 18 is a cable having flexibility and a ribbon-like shape. The FPC 8 has, for example, a configuration in which conductor patterns are provided on a surface of a film made of resin. As a configuration of the FPC 8, a configuration in which plural sets of a film made of resin and conductor patterns are laminated may also be used.

An end portion of the FPC 8 is connected to the connector 1 according to the embodiment.

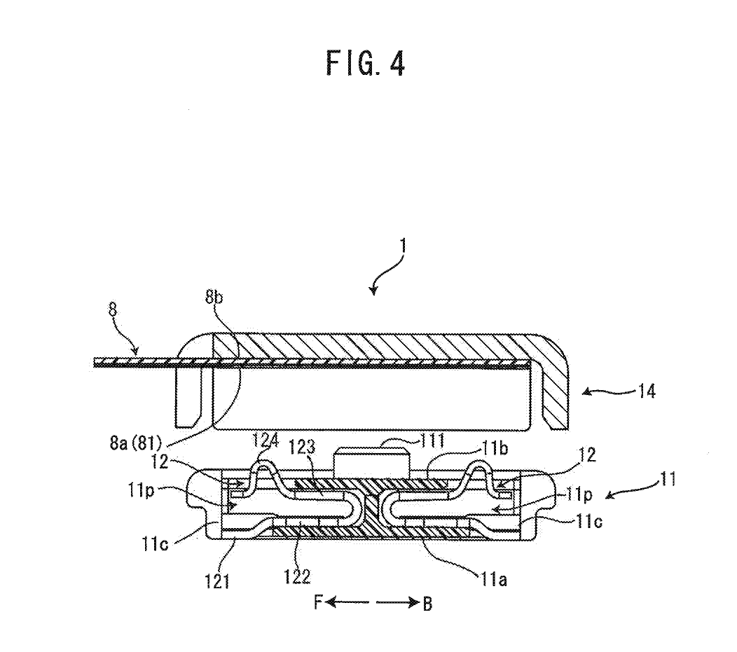

Terminal patterns 81 (see FIG. 4) are provided on a terminal surface 8a which is a bottom surface opposite to a top surface 8b shown in FIG. 1 of the FPC 8. The terminal patterns 81 (see FIG. 4) are end portions of electrically conductive patterns extending on the terminal surface 8a. However, if the FPC has a configuration in which plural sets of a film made of resin and conductor patterns are laminated, the terminal patterns 81 (see FIG. 4) may be conductors which are connected via through holes to the conductor patterns sandwiched respectively between the plural films made of resin. Incidentally, the terminal patterns also may be provided on the top surface 8b opposite to the terminal surface 8a.

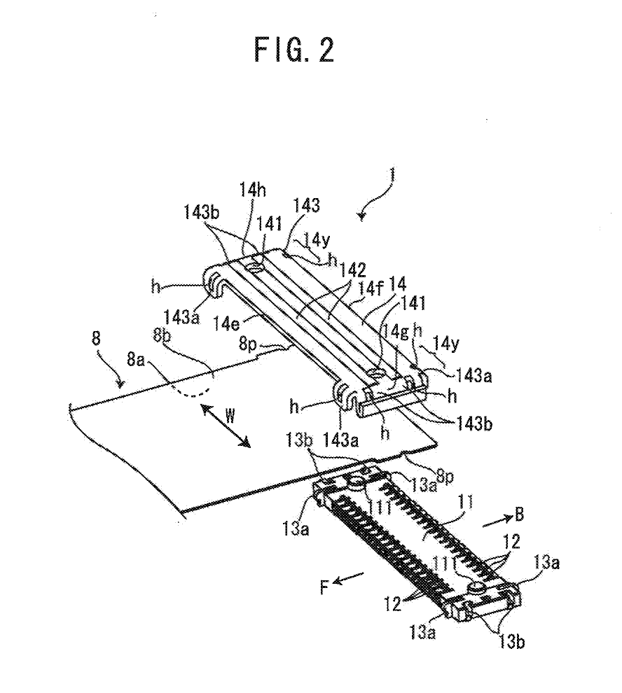

Now with reference to FIGS. 2-7, the connector 1 is shown that may include a housing 11, contacts 12 and a cover member 14. Incidentally, FIG. 2 also shows the FPC 8. The end portion of the FPC 8 is sandwiched between the cover member 14 and the housing 11.

In an exemplary embodiment, the housing 11 has an approximately rectangular and tabular and is formed by electrically insulating resin material. The housing 11 is arranged in a state in which the bottom surface 11a is opposed to the circuit board 9 (see FIG. 1). The top surface 11b of the housing 11 is opposed to the terminal surface 8a of the FPC 8 on which the terminal patterns 81 are formed.

In an exemplary embodiment, a pair of positioning protrusions 111 are provided on the top surface 11b of the housing 11. Each of the pair of positioning protrusions 111 is arranged with a space therebetween corresponding to a width of the FPC 8. In contrast, As shown in FIG. 2, notches 8p into which the positioning protrusions 111 enter are provided on both side edges in a width W of the FPC 8.

The positioning protrusions 111 of the housing 11 enter the notches 8p when the FPC 8 is put on the top surface 1 lb of the housing 11, thereby positioning the FPC 8 with respect to the housing 11.

In an exemplary embodiment, contact receiving grooves 11p are provided in side surfaces 11c along a width W of the housing 11. Contacts 12 are accommodated in the contact receiving grooves 11P. The contacts 12 are arranged in two rows. Each of the rows of the contacts 12 extends along the width W.

In an exemplary embodiment, the contacts 12 are formed by stamping and forming an electrically conductive metal plate. Each of the contacts 12 includes a board connection section 121, a press-fit section 122, an elastically deforming section 123 and a contact section 124. The board connection sections 121 are exposed on the bottom surface 11a of the housing 11. The board connection sections 121 are connected by solder to an electrically conductive pattern (not illustrated) of the circuit board 9 (see FIG. 1), respectively. Each of the press-fit sections 122 is a portion to be press-fit into each of the contact receiving grooves 11p of the housing 11. The board connection sections 121 of the contacts 12, press-fit into the housing 11, are connected by solder to the circuit board 8 (see FIG. 1), so that the housing 11 is indirectly secured to the circuit board 9 (see FIG. 1). The elastically deforming sections 123 are provided between the press-fit sections 122 and the contact sections 124, and are deformed according to external forces received by the contact sections 124, respectively. The contact sections 124 are portions to make contact with the terminal patterns 81 of the FPC 8, respectively. The contacts 12 are accommodated in the housing 11 in a state in which the contact sections 124 protrude from the top surface 1 lb of the housing 11, respectively.

In an exemplary embodiment, the housing 11 includes eight lock sections 13a, 13b. The eight lock sections 13a, 13b are arranged on side surfaces 11c, 11d of the housing 11. More specifically, each of the eight lock sections 13a, 13b is a claw, and is formed by a conductive metal piece (peg) secured to the housing 11.

In an exemplary embodiment, four first lock sections 13a out of the eight lock sections 13a, 13b are arranged on an extension line from each of the two rows of the contacts 12. The first lock sections 13a are arranged on the side surfaces 11c extending in the width W of the housing 11, respectively. Each of the first lock sections 13a includes a board connection section 131, a press-fit section 132 and a lock claw section 133. The board connection section 131 is a portion to be connected by solder to the circuit board 9 (see FIG. 1). In addition, the press-fit sections 132 are portions to be press-fit to the housing 11. The lock claw sections 133 protrude in hook shapes from the side surfaces 11 c of the housing 11 in directions approximately perpendicular to the width W of the housing 11. The lock sections 13a press-fit to the housing 11 are connected by solder to the circuit board 9 (see FIG. 1), so that the housing 11 is indirectly secured to the circuit board 9 (see FIG. 1).

In an exemplary embodiment, the remaining four second lock sections 13b out of the eight lock sections 13a, 13b are arranged on more outer sides in the width W than the first lock sections 13a. Each of the second lock sections 13b is a metal piece having a configuration similar to those of the first lock sections 13a. However, each of the second lock sections 13b has a shape of being curved halfway. The second lock sections 13b protrude in the width W from the side surfaces 11d of the housing 11, which side surfaces 11d extend in directions approximately perpendicular to the width W.

In an exemplary embodiment, the cover member 14 is a tabular member portions of whose edges are curved. As shown in FIG. 2, the cover member 14 has a rectangular shape longer than the width of the FPC 8. FIG. 2 also shows the cover member 14 being separated from the FPC 8. However, in a process in which the FPC 8 is connected to the connector 1, the cover member 14 is secured to the FPC 8 in advance. In addition, the housing 11 is secured to the circuit board 9 (see FIG. 1). Subsequently, the FPC 8 to which the cover member 14 is secured is connected to the housing 11.

The cover member 14 is secured to the top surface 8b which is the surface opposite to the terminal surface 8a of the FPC 8. More specifically, the cover member 14 is adhered to the FPC 8. The cover member 14 is adhered to the FPC 8 in which both side edge portions of the cover member 14 extend off from both sides of the FPC 8 along the width W. The portions of the cover member 14 extended off from the FPC 8 are referred to as extensions 14y.

In an exemplary embodiment, the cover member 14 is formed by stamping, pressurizing and forming an electrically conductive metal plate. The cover member 14 includes guide openings 141 which the positioning protrusions 111 of the housing 11 enter. The positioning protrusions 111 and the guide openings 141 guide movement during connected. In addition, the cover member 14 includes two ridges 142 which extend upward and along the width W. Since the cover member 14 is reinforced by the ridges 142, deformation of the cover member 14 is reduced.

In an exemplary embodiment, the cover member 14 includes first locks 143a provided at four positions and second locks 143b provided at four positions. The first locks 143a lock to the first lock sections 13a attached to the housing 11, and the second locks 143b lock to the second lock sections 13b. The locks 143a, 143b are portions turning from edges of the extensions 14y of the cover member 14 to extend toward the housing 11 (in other words, downward).

Two first locks 143a arranged on a side of the forward F out of the four first locks 143a extend downward from both end portions in an edge 14e in the forward F of the cover member 14, in other words, from edges on both sides in the width W of the extensions 14y. In addition, the first locks 143a extend downward from an edge 14f. The first locks 143a extend from the extensions 14y arranged at the two positions along the width W, and each of the first locks 143 is a one-piece protrusion piece continuing across all over the edge 14f. Each of the first locks 143a arranged at the four positions includes a lock opening h which the first lock section 13a enters.

The second locks 143b are portions turning from edges 14g, 14h on both sides along the width W of the cover member 14 and extending toward the housing 11 (in other words, downward). Two out of the four second locks 143b extend from the one edge 14g, and remaining two out of them extend from the other edge 14h. The second locks 143b extending from the above-described one edge 14g extend from two positions on sides along the edge 14g, and the second locks 143b of the shown embodiment are included in a one-piece protrusion piece continuing across all over the edge 14g. Regarding the other edge 14h, the second locks 143b extend from two positions on sides, and the second locks 143b are included in a one-piece protrusion piece continuing across all over the edge 14h. Each of the four second locks 143b includes a lock opening h which each of the second lock sections 13b secured to the housing 11 enters. Incidentally, a tip of each of the second locks 143b further turns back to extend upward. By turning back, strength against deformation is improved.

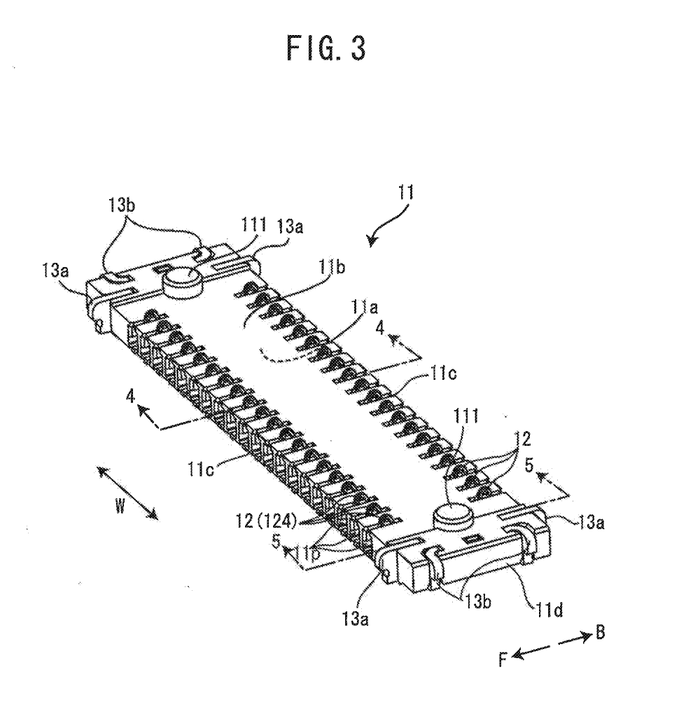

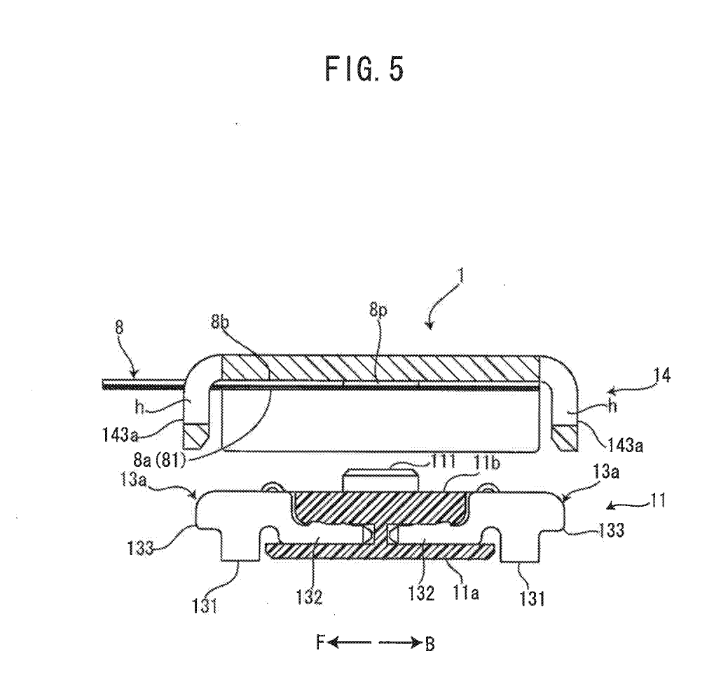

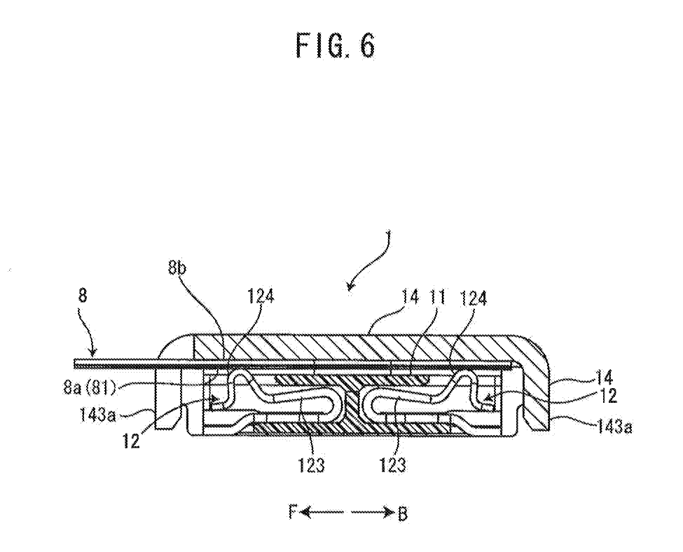

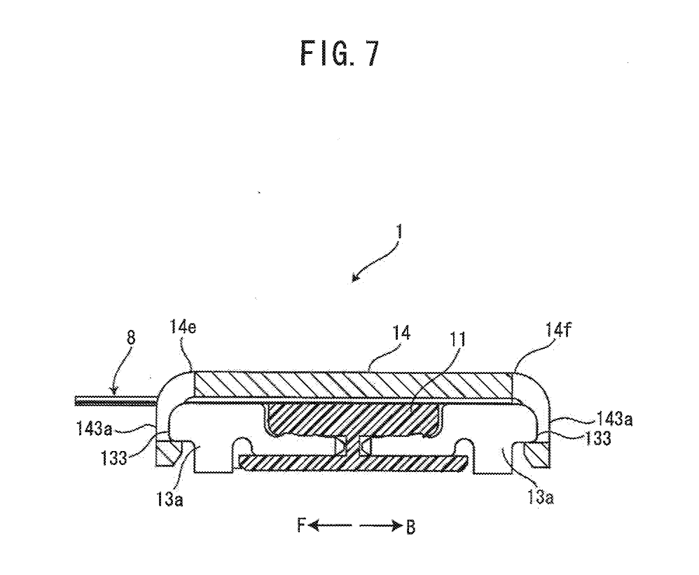

As shown in FIGS. 4 and 5, when the FPC 8 to which the cover member 14 is adhered is moved downward toward the housing 11, the terminal patterns 81 of the FPC 8 make contact with the contact sections 124 of the contacts 12. When the FPC 8 is further pressed downward, the FPC 8 presses against the contacts 12, and the elastically deforming sections 123 of the contacts 12 are elastically deformed, as shown in FIG. 6. In addition, as shown in FIG. 7, the first locks 143a of the cover member 14 secure to the lock claws 133 , which protrude from the side surfaces 11 c (see FIG. 3) of the housing 11. In addition, the second lock 143b (see FIG. 2) of the contacts 12 secure to the second lock sections 13b (see FIG. 2) that are secured to the housing 11. Accordingly, the cover member 14 and the FPC 8 are prevented from being pulled out from the housing 11. In addition, as shown in FIG. 6, the contact sections 124 of the contacts 12 are pressed against the terminal patterns 81 of the FPC 8 by the elastic forces of the elastically deforming sections 123. Accordingly, a secure connection is retained. As a result, the contact sections 124 of the contacts 12 are electrically connected using the contacts 12 to the conductor patterns (not illustrated) of the circuit board 9 (see FIG. 1). In addition, the FPC 8 is covered by the cover member 14 made of the electrically conductive material. Since the cover member 14 functions as an electromagnetic shield, effects by electromagnetic radiation and exogenous noise are reduced.

Since four corners of the cover member 14 to which the FPC 8 is adhered lock to the housing 11 by the four first locks 143a and the four first lock sections 13a, the contacts 12 abut on the terminal patterns 81 of the FPC 8 by forces which are equivalent to each other, respectively. In addition, since the cover member 14 is further locked to the housing 11 by the second locks 143b and the second lock sections 13b, the cover member 14 is more securely prevented from being pulled out.

In addition, the locks 143a, 143b secure to the lock claws 133 of the lock sections 13a, 13b, respectively, and thus, the cover member 14 and the circuit board 9 (see FIG. 1) are electrically conductively connected to each other. For this reason, in the connector 1 of the shown embodiment, a dedicated member for electrically conductively connecting the cover member 14 and the circuit board 9 (see FIG. 1) is not required.

In the connector 1 of the shown embodiment, both of the first locks 143a and the second locks 143b extend from the edges of the cover member 14 over the FPC 8 toward the housing 11. Both of the first locks 143a and the second locks 143b secure to the side surfaces 11c, 11d of the housing 11. Accordingly, the lock configuration is arranged in a height same as those of the contacts 12, and does not exist over the FPC 8. Accordingly, the connector 1 is made low profile, compared to, for example, a configuration in which a lock configuration is provided over a cover member.

In addition, the connector 1 of the shown embodiment is connected without deforming the FPC 8 while maintaining the plate shape thereof. Thus, compared to a configuration in which an FPC is deformed when being connected, a force of connecting is reduced. Accordingly, the operation of the connecting is easy. In addition, since the FPC is not deformed, the reliability is improved.

In addition, the cover member 14 is adhered to the FPC 8 before the housing 11 is connected to the FPC 8. For this reason, at the time of connecting operation, it is not required to hold the FPC 8 and the cover member 14 independently. Accordingly, the operation of the connecting is made simple.

When the FPC 8 is removed in the shown embodiment, a jig is inserted between the first locks 143a, the second locks 143b and the housing 11 to release the locking The removed FPC 8 is not bent and has the same shape as that before being attached. Accordingly, it is easy to remove the FPC 8 and make a connection again.

Incidentally, in the above-described embodiment, as an example of the lock according to the invention, the first locks 143a and the second locks 143b are described. However, the present invention is not limited to this. For example, either of the first locks or the second locks may be arranged. In addition, the respective number of them may be two or three or 5 and more.

In addition, in the shown embodiment, as an example of the locks according to the invention, the first locks 143a and the second locks 143b secure to the lock sections 13a, 13b which are made of metal and secured to the housing are described. However, the present invention is not limited to this. For example, a mating member to which the locks secure may be a protrusion which is integrally formed with a housing. In addition, in the shown embodiment, as an example of the locks according to the invention, the first locks 143a and the second locks 143b both having lock openings h are described. However, the present invention is not limited to this. The locks may have, for example, hooks which lock to concave sections provided in a housing.

In addition, in the above-described embodiment, as an example of the lock according to the present invention, the first locks 143a and the second locks 143b connected across all over the edges 14f, 14g, 14h of the cover member 14 are described. However, the invention is not limited to this. For example, the locks may be separated from each other, like the locks 143a extending from the edge 14e in the forward F. The connector 1 in the shown embodiment is connected to the end portion of the FPC 8, and however, for example, in a case of being connected to a midpoint of a ribbon-like-shaped FPC, the locks may extend from the backward edge also are separated from each other, like the ones in the forward.

In addition, in the above-described embodiment, the connector 1 to be connected to the FPC 8 is described. However, the present invention is not limited to this. What is connected to the connector may be, for example, an FFC.

In addition, in the above-described embodiment, as an example of the cover member, the cover member 14 made of the electrically conductive material is described. However, the invention is not limited this. For example, the cover member may be insulative.

In addition, in the above-described embodiment, as an example of the FPC, an FPC on whose bottom surface the terminal patterns 81 are arranged is described. However, the invention is not limited to this. For example, a ground pattern to make contact with a cover member or a conductor pattern for electrical power supply or signal may be arranged also on a top surface. In this case, the FPC 8 and the circuit board 9 may be electrically conducted via the cover member 14 and the lock sections (pegs) 13a, 13b.

Further, securing the FPC 8 and the cover member 14 to each other may be secured by mechanical means such as a crimping apparatus as well as fixing by an adhesive.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. A flat cable connector, comprising:
a housing having a top surface, a side surface adjacent the top surface, and a lock section disposed along the side surface;
a contact located in the housing and having a portion protruding from the top surface; and
a cover member having a planar surface, a lock extending from the planar surface and being engageable with the lock section.

2. The flat cable connector according to claim 1, wherein the housing is tabular.

3. The flat cable connector according to claim 1, wherein the planar surface is tabular.

4. The flat cable connector according to claim 1, wherein the cover member is formed of an electrically conductive material.

5. The flat cable connector according to claim 4, wherein the housing includes an electrically conductive lock claw.

6. The flat cable connector according to claim 1, further comprising a second lock section positioned opposite the lock section.

7. The flat cable connector according to claim 6, further comprising a second lock positioned opposite the lock.

8. The flat cable connector according to claim 1, wherein the lock section includes a claw having a conductive metal piece secured to the housing.

9. The flat cable connector according to claim 8, wherein the lock section includes a board connection section, a press-fit section, and a lock claw section.

10. The flat cable connector according to claim 9, wherein the lock claw section protrudes from the side surface of the housing perpendicular to a major surface of the housing.

11. The flat cable connector according to claim 1, further comprising a pair of positioning protrusions disposed on the top surface of the housing.
